(19) United States
(12) Patent Application Publication
(10) Pub. No.: US 2010/0077923 A1
(43) Pub. Date: Apr. 1, 2010

(54) Filter apparatus and method

(76) Inventor: Travis Lewis, Valdosta, GA (US)

Correspondence Address: LANGDALE & VALLOTTON, LLP, 1007 N. PATTERSON STREET, VALDOSTA, GA, 31601, US

(21) Appl. No.: 12/286,329

(22) Filed: Sep. 30, 2008

(51) Int. Cl. B01D 46/20; B01D 46/46

(52) U.S. Cl. 96/18; 55/354

(57) ABSTRACT

An air filter system for installation within the air inlet duct for an air conditioning system has a pair of mandrels that establish sufficient friction force when a web of fresh filter fabric is drawn from a supply roll to eliminate most undesirable wrinkles and slackness in the web. The “pop-off” feature of the fresh filter fabric supply and contaminated filter fabric storage magazines with a removable side enable a fresh roll of filter fabric to be installed in the system with minimal disagreeable effort. A peripheral step that protrudes from the base of the system enables the system to be adaptable to many existing air conditioner ducting structures. A back-up secondary filter, preferably treated with the activated carbon, permits less-than-particulate contamination, e.g. odors and noxious gases to be removed from the incoming air stream. Electrical circuits that control the sequential cycles for replacing the filter fabric webs, signals each progressive cycle and provide system condition cues are also described.

### CROSS-REFERENCES TO RELATED APPLICATIONS

None

### FEDERALLY SPONSORED RESEARCH OR DEVELOPMENT

None

### NAMES OF PARTNERS TO A JOINT RESEARCH AGREEMENT

None

### REFERENCE TO “SEQUENCE LISTING”

None

### BACKGROUND OF THE INVENTION

This invention relates to a filter apparatus and method and, more particularly to a high volume air conditioner filter that provides up to one year of air filtration with simplified filter fabric replacement, better filter fabric tension control, improved filter cycle regulation, and the like.

Although filters in high volume air conditioner systems (HVAC) should be replaced whenever the filter fabric becomes so obstructed with particulate matter that it significantly degrades the efficiency of the HVAC system, this generally disagreeable task is all to frequently overlooked. In most instances, the grating at the air inlet to the HVAC system must be removed, a large, rectangular frame supporting the used, dust laden filter fabric in a position generally perpendicular to the direction of air flow into the system must be discarded, replaced with a new, fresh filter and the grating reinstalled.

Proposals have been advanced to alleviate this distasteful burden through various means. Illustratively, according to one proposal a portion or web of filter fabric is drawn into position behind the grating and in front of the HVAC air inlet duct from a filter fabric supply in response to a predetermined loss in air pressure across the previously exposed web of filter fabric. These proposals, however, are subject to a number of serious disadvantages. For example, threading the leading edge of filter fabric from a supply through the filter support structure is an aggravating task. Maintaining the tension on the exposed fresh web of the filter fabric to avoid wrinkle formation and slackness involved complicated albeit unsatisfactory clutch or spring drag structures.

Other important characteristics of a truly satisfactory HVAC filter structure also are lacking in the prior art. For instance, a low battery power alert signal; a secondary filter to provide a further level of protection from non-particulate contaminants, e.g. odors and noxious gases; improved filter fabric advance control to reduce the frequency of filter fabric replacement; adaptability of the filter system to a range of HVAC systems and the like all are lacking in these earlier proposals.

Consequently, a need exists for an improved HVAC filter system that overcomes the inadequacies that have characterized these earlier proposals.

### BRIEF SUMMARY OF THE INVENTION

These and other unsatisfactory inadequacies in prior filter system designs are largely overcome through the practice of the invention.

For example, in accordance with the principles of the invention a battery powered HVAC filter system automatically removes an unclean or contaminated web of filter fabric and replaces it with a clean, fresh web of fabric on a selectively timed cycle. The frame or box for supporting the filter structure has attached to it through “pop-off” detents a supply magazine for storing an uncontaminated roll of filter fabric from which webs of fresh fabric are successively drawn in a manner that can provide up to one full year of efficient filtration. A specific feature of this invention, moreover, is the use of control chucks for maintaining sufficient tension in the fresh fabric web to keep the web properly exposed and positioned across the HVAC air intake while preventing slackness and wrinkle formation in the freshly exposed fabric web. The contaminated webs of fabric are rolled up in a contaminated fabric storage magazine that also is selectively attached to the box through a set of “pop-off” detents.

By removing the magazines, the leading edge of the filter fabric is drawn from a fresh roll of the fabric, and is attached to a take-up roll mandrel for spooling and storing contaminated fabric. A web of filter fabric also is drawn from the fresh roll of fabric and the entire assembly then is slipped transversely into the box. The magazines are then snap fitted to their respective ends of the box. The heretofore tedious and dirty job of threading the leading edge from a roll of fresh fabric through the passages that characterized prior art proposals is eliminated. The box also has a peripheral step that permits the filter apparatus to be seated within the air intake cavity behind the HVAC grate for many air conditioner ducts in a manner that establishes maximum filter fabric web surface area exposure to the incoming air stream. An additional advantage of this box is that the roll of dirty, used filter fabric is contained within the storage magazine on one side of the box while the clean roll is protected from contamination in the supply magazine on the other side of the box.

A secondary filter also is mounted within the box, this filter being a high efficiency particulate air (HEPA) filter. The secondary filter separates not only further particulate matter from the incoming air stream, but if carbon based it will provide maximum levels of air purification by absorbing and eliminating, from the incoming air stream irritating odors and hazardous gases.

The electrical control circuit for the filter system also enables a number of novel features to be utilized that are not suggested in prior filter proposals. Illustratively, central to the many operational characteristics of the filter system is a microcontroller that times all system functions, economizes battery power, drives the visual and audible system status displays, and drives the filter fabric through the sequence of predetermined timed cycles—including filter fabric and battery replacement warnings.

These and other features that largely overcome the disadvantages of earlier filter system proposals are provided through the practice of the invention, a detailed description of the preferred embodiment of the invention being provided below. The scope of the invention, however, is limited only through the claims appended hereto.

### BRIEF DESCRIPTION OF THE DRAWING

FIG. 1 is a perspective view of a filter structure embodying principles of the invention;

FIG. 2 is an exploded perspective view of the filter structure shown in FIG. 1.

FIG. 3 shows, in broken and full section a detail of part of the mechanism for maintaining proper tension in the fabric web, taken along the line 3-3 of FIG. 1, and viewed in the direction of the arrows;

FIG. 4 is a detail view in broken section of a portion of the filter structure shown in FIG. 2 taken along the line 4-4 of FIG. 2 and viewed in the direction of the arrows;

FIG. 5 is a perspective view of a portion of the filter structure shown FIG. 1 with some of the structure removed;

FIG. 6 is a side elevation of the filter structure in partially broken section embodying principles of the invention as practiced during filter fabric replacement and removal;

FIGS. 7A and 7B each show in side elevation the winder chucks for the storage magazine shown in FIG. 2;

FIG. 8 is an illustrative mounting for the filter structure shown in FIG. 1 within the ducting for a typical air conditioning system;

FIG. 9A through 9D are schematic diagrams of the electrical circuits that control the operation of the apparatus shown in FIG. 1; and

FIG. 10 shows in an enlarged, broken section the control switches for the filter structure shown in FIG. 1.

### DETAILED DESCRIPTION OF THE PREFERRED EMBODIMENT OF THE INVENTION

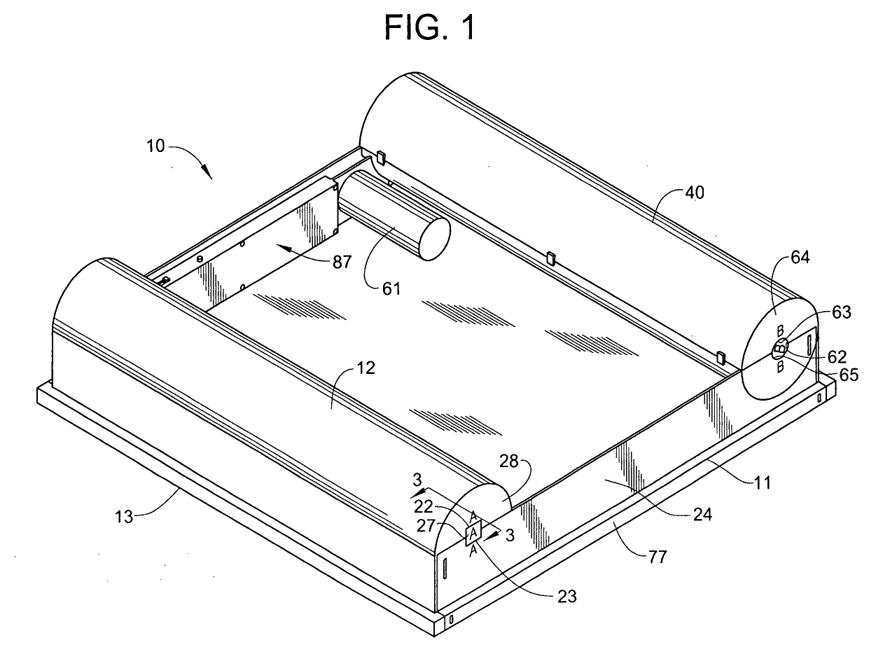

For a more complete appreciation of principles that characterize salient features of the invention attention is invited to FIG. 1 which shows the HVAC filter system 10. The system 10 is encased within a frame or box 11, preferably formed from a molded plastic. Prominent in the structure of the box 11 is a semi-cylindrical, hollow supply magazine 12 mounted on one end 13 of the box 11.

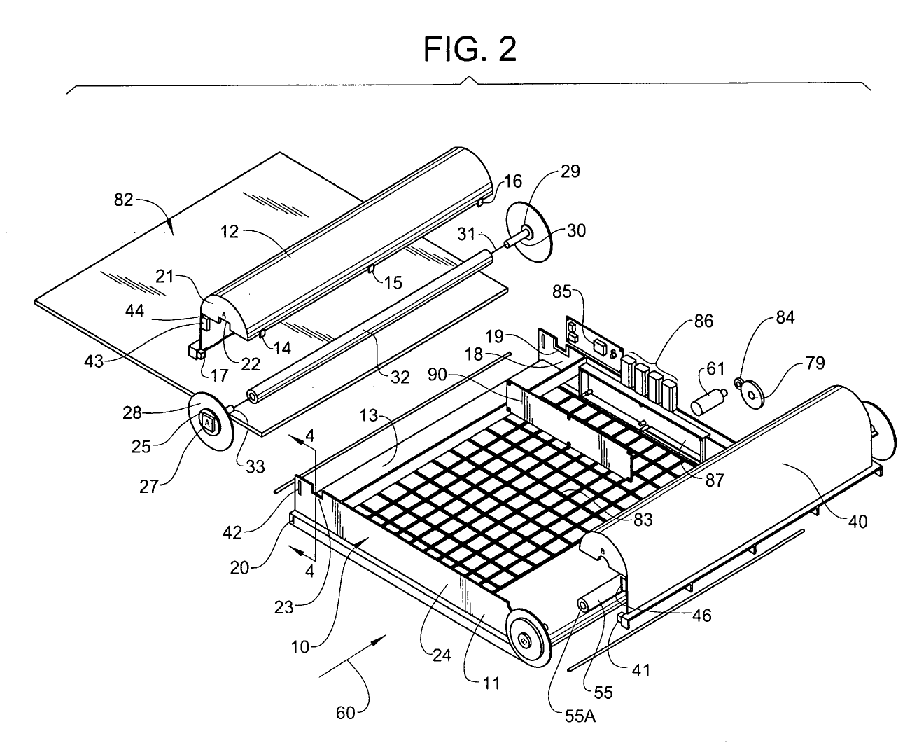

As best illustrated in FIG. 2 the supply magazine 12 has a group of detents of which only detents 14, 15, 16, 17 are shown in FIG. 2. The detents 14 through 17 are each, respectively engaged in corresponding detent couplings, of which only the detent coupling 20 on the box 11 is shown in FIG. 2. The detents 14 through 17 enable the supply magazine 12 to selectively “pop off” and snap fit to the box 11. The semicircular ends, of which only end 21 is shown in FIG. 2 is provided with one half of a rectangular journal 22 that meets with another rectangular journal half 23 formed in side 24 of the box 11 as shown in FIG. 1. Side 18 on the box 11 also is provided with a square journal, equivalent to the journal halves, when joined, on the side 24 of the box 11, of which only journal half 19 in the side 18 is shown.

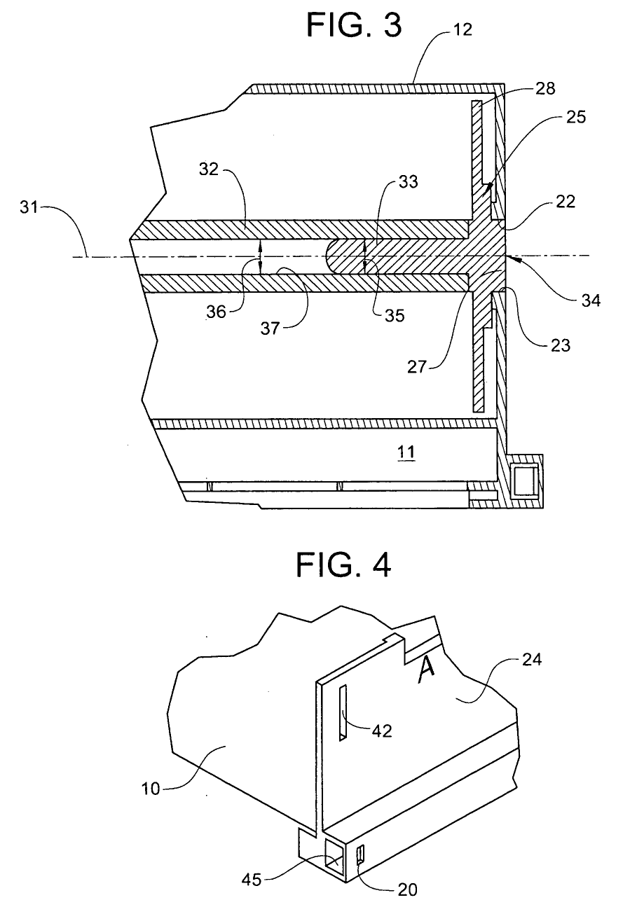

A pair of circular ends 25 (FIG. 2), of which only the circular end 25 shown are nested within the supply magazine 12. These circular ends are each also provided on respective circular disks with rectangular or square bearings, of which only square bearing 27 on disk 28 is shown in FIG. 2. The square bearing 27 is received within a journal 34 (FIG. 3) that is formed by the journal halves 22, 23 when the supply magazine 12 is joined to the box 11. So assembled, the square journal bearing 27 is immobilized in the journal 34 by the journal halves 22, 23. Shown only in part in FIG. 2 is an equivalent square, immobilized journal structure formed on the disk 29 by the journal halves (of which only the journal half 19 is illustrated in FIG. 2) at the end of the supply magazine 12 that is opposite to the position of the disk 28.

In accordance with a feature of the invention an immobile supply chuck 30 protrudes from the center of the circular disk 29 inwardly toward the interior of the hollow supply magazine 12 in alignment with axis 31 for a cardboard tube on which the roll of fresh filter fabric (not shown in FIGS. 1 and 2) is mounted or a hollow supply mandrel 32.

For a more complete understanding of this feature of the invention, turn to FIG. 3 of the Drawing. As illustrated, the supply magazine 12 encloses the circular disk 28. The square bearing 27 on the disk 28 protrudes through the journal 34 that is formed by the journal halves 22, 23 and is thus immobilized relative to the supply magazine 12. Another supply chuck 33 protrudes inwardly toward the interior of the supply magazine 12 in alignment with the axis 31 that is common to the supply magazine 12, the chuck 33, and the supply mandrel 32.

Unique to this invention is chuck diameter 35 relative to a diameter 36 for hollow interior 37 of the supply mandrel 32. In accordance with the invention the chuck diameter 35 is slightly oversized, or greater than the diameter 36 of the hollow interior for the supply mandrel 32. Although not shown in FIG. 3 the chuck 30 (FIG. 2) that protrudes into the hollow interior 37 (FIG. 3) of the supply mandrel 32 also has a slightly oversized diameter, essentially the same as that of the chuck 33, relative to hollow interior 37.

Thus, as described subsequently in more complete detail, as a web of fresh filter fabric is drawn from a supply roll (not shown in FIGS. 1 and 2), the friction force established between the oversized diameters (of which only the diameter 35 is shown in FIG. 3) of the immobile chucks 30, 33 and the corresponding smaller diameter 36 of the hollow interior 37 of the supply mandrel 32 that presses against the surfaces of the chucks 30 (FIG. 2) and 33 (FIG. 3) create a retarding friction force between the chucks 30, 33 and the mandrel 32 that provides a tension in the web of fresh filter material (not shown in FIG. 2 and FIG. 3). This tension, in accordance with the invention generally prevents wrinkles and slack from developing in the portion of the web that was drawn from the roll.

A further salient characteristic of the invention illustrated in FIG. 2 is the “pop-off” feature of the side 24 of the box 11, the supply magazine 12 and contaminated storage magazine 40. Although only the storage magazine detent 41 is illustrated in FIG. 2, the storage magazine 40 nevertheless enjoys essentially the same snap fitting detents as the detents 14 through 17 described above in connection with the supply magazine 12. With respect to the selectively removable nature of the side 24, attention now is invited to a corner detail for the side 24 illustrated in FIGS. 2 and 4. As shown, the side 24 is provided with a coupling 42 for selectively engaging a detent 43 (FIG. 2) that protrudes in the direction of the axis 31 from the adjoining side of the supply magazine 12 immediately below the base of the semi circular end 21 of the supply magazine 12. Similarly, the detent 17 protrudes toward the side 24 from a skirt 44 that depends from the semi cylindrical supply magazine 12 and is aligned with and is selectively pressed into a corresponding aperture 45 (FIG. 4) in the base of the side 24 in order to join the side 24 to the box 11.

Contaminated storage magazine 40 is provided with a corresponding set of detents, of which only detent 41 and detent 46 are shown in FIG. 2. These detents similarly are engaged with corresponding couplings (not shown in the Drawing) in that end of the side 24 that is closest to the contaminated storage magazine 40. Accordingly, to remove the side 24 from the filter system 10 it is only necessary, relying on the elasticity of the detents, to separate, or “pop off” the supply magazine 12 and the storage magazine 40 from the side 24, and then remove the side 24 from its position on the box 11. Replacing the side 24 is achieved by placing the side 24 in position on the box 11 and pressing the detents (of which only the detents 14 through 17, 43 and 46 are shown in FIG. 2), into their respective couplings (e.g. the couplings 20, 42 and 45).

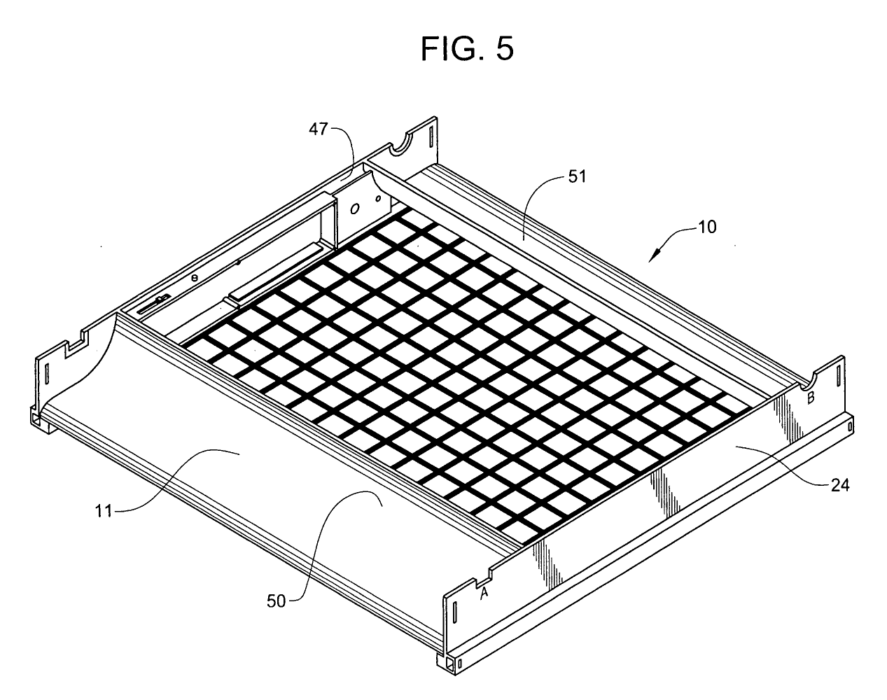

Attention now is invited to FIG. 5 which shows the box 11 with the side 24 and a side 47, opposite to the side 24 attached to the box 11. Notice particularly curved surfaces 50 and 51 on the box 11 associated, respectively, with the supply magazine 12 and the storage magazine 40 (magazines 12 and 40 are not shown in FIG. 5).

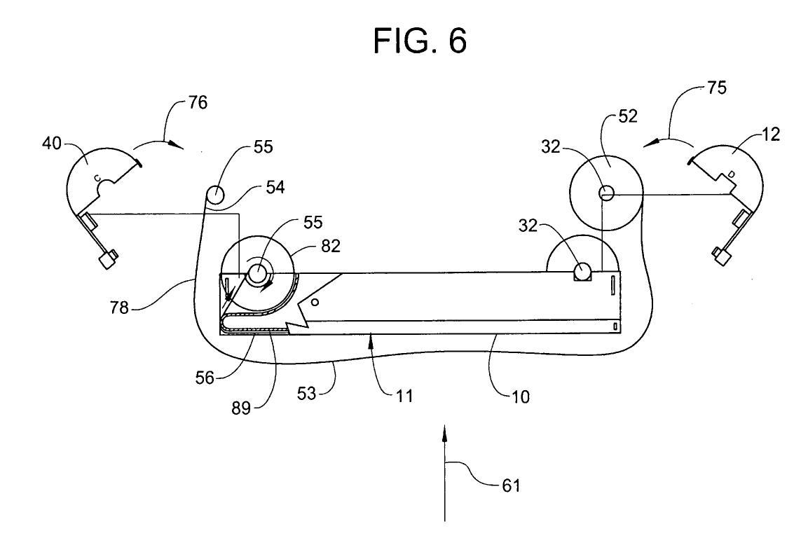

In accordance with another feature of the invention, it should be noticed that the radius of curvature for each of the surfaces 50 and 51 on the box 11 are respectively generally slightly greater than the radius of a fresh, clean full roll of filter fabric (the surface 50) and a full roll of contaminated filter fabric (the surface 51). To load the filter system 10 with a fresh roll of filter fabric please note FIG. 6. As shown, the supply magazine 12 and the contaminated storage magazine 40 have been removed, or “popped off” the box 10. A roll of clean, fresh filter fabric 52 is mounted on the supply mandrel 32. The side 24 (not shown in FIG. 6) is removed in the manner described above. A web of filter fabric 53 is manually drawn from the roll 52 and leading end 54 of the web is attached by an adhesive or a spring clip, or the like (not shown in the Drawing) to a contaminated storage mandrel 55.

Filter fabric suitable for use in connection with the invention can be purchased from manufacturers with “needle punched” or air laid, or both, synthetic nonwoven production capabilities. Preferably, the manufacturer should have a background in filtration fabric. Illustrative suppliers of suitable filter fabric with these capabilities are Kimberly-Clark Corporation, 3M Corporation and Freudenberg Nonwovens.

The filter fabric web 53 is slipped transversely into a track 56 formed in the box 11 in the direction of arrow 60 (FIG. 2) through the open side of the box 11 provided by the removal of the side 24. The roll 52 of fresh filter fabric then is mounted in the immobile journal 34 (FIG. 3) in the manner described above by inserting the oversized chucks 30 and 33 into the hollow interior 37 of the supply mandrel 32. The square bearing 27 (FIG. 2) is then seated in the journal half 23 and the supply magazine 12 is snapped into place, the radius of curvature for the fresh filter fabric roll 52 (FIG. 6) being slightly less than the radius of the corresponding curved surface 50 (FIG. 5) in the box 11 to provide clearance for the roll 52 (FIG. 6).

To position the filter fabric web 53 in the filter system 11 it should be noted that while the supply chucks 30 and 33 (FIG. 2) do not rotate in order to establish a suitable tension in the filter fabric web 53 when loading the roll 52 of fresh filter fabric into the filter system 10 web 53 is drawn manually from the roll of fresh filter fabric 52, overcoming the friction forces set up between the chucks 30, 33 and the supply mandrel 32. During normal operation of the filter system 10, however, the power to draw the web 53 across the surface of the box 11 in a direction perpendicular to that of the arrow 60 (FIG. 2) is provided by means for rotating the contaminated filter fabric storage mandrel 55, e.g. an electric motor 61 (FIGS. 1 and 2). Accordingly, the storage mandrel 55 within the contaminated storage magazine 40 rotates.

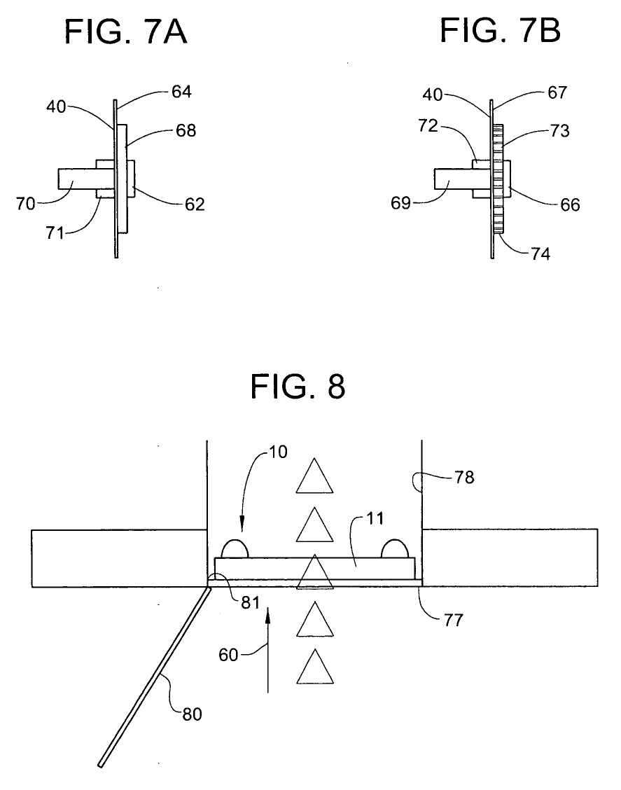

In this respect, note that journal 62 (FIG. 1) is circular in its shape. The circular journal 62 is formed, moreover, by a semi circular journal half 63 in semi circular end 64 of the storage magazine 40. The other half of the journal 62 is formed by a corresponding, aligned semicircular journal half 65 in the edge of the side 24 that supports the storage magazine 40. Not shown in FIG. 1, but illustrated in FIG. 7B is a corresponding circular journal 66 formed in a semicircular end 67 of the storage magazine 40.

Turning now to FIG. 7A a circular end member 68 is interposed between the circular journal 62 and the storage magazine 40. Storage or winder chuck 70 is joined to the circular end member 68 by means of a key 71 that enables the winder chuck 70 to rotate while seated in the journal 62.

A corresponding circular journal 66 in FIG. 7B, on the side of the storage magazine 40 that is opposite to the journal 62 receives an end of another storage or winder chuck 69 in the journal 66 for rotation with the winder chuck 70 that is seated in the journal 62. The winder chuck 69 also is joined by a key 72 to a winder gear 73. The gear 73 is sandwiched between the journal 66 and the storage magazine 40. The chuck 69 is driven, in a manner described subsequently in more complete detail. In rotation the winder chucks 69 and 70 drive the contaminated storage mandrel 55 (FIG. 6). In this way, the motor 61 establishes a suitable tension in the filter fabric web 53 to prevent wrinkles formation and a slack web 5, while also enabling an appropriate clean width of the filter fabric web 53 to be stretched across the box 11, a contaminated width 82 being rolled up in the mandrel 55 in the storage magazine 40.

Further in this regard, in loading the fresh roll 52 into the box 11 having joined the leading end 54 from the filter fabric web 53 to the contaminated storage mandrel 55 as described above, the mandrel 55 and its conjoined winder chucks 69, 70 are seated in their respective journals 66, 62 (FIGS. 7A, 7B). The storage mandrel 55 (FIG. 6) then is rotated manually to establish a tension in the filter fabric web 53 that will eliminate wrinkles and slack in the web 53. The sides 24 and 47 (FIG. 5) are pressed into place at the side of the box 11, whereupon the supply magazine 12 and the contaminated storage magazine 40, also are snapped into place by pressing these magazines 12, 40 (FIG. 6) in the direction of their respective arrows 75, 76 to engage the individual magazine dents (FIG. 2) with the corresponding couplings on the sides 24, 47. In this way the molded construction of the box 11 and the curved surfaces 50, 51 (FIG. 5) enable a fresh supply of filter fabric to be inserted into the filter system 10 without the need to undertake the irritating job of the tracing the leading end of the fresh fabric web through a series of bends, turns and slots which is so characteristic of earlier filter system proposals.

Recall that one of the salient features of the invention is the adaptability of the filter system to existing intake ducting for almost any standard HVAC equipment. Toward this end, attention is once more invited to FIG. 1 which shows a peripheral step 77 that extends around the perimeter of the base for the box 11. Preferably, the step 77 is about ¾″ in thickness and protrudes from the box 11 about ¾″ in width. Temporarily removing or opening a grate 80 (FIG. 8) for an air conditioner air intake duct 78 exposes a small flange 81 that is recessed within the HVAC duct 78 and which extends around the inner surface of the duct 78. The peripheral step 77 for the box 11 is seated on the flange 81, the balance of the HVAC filter system 10 being received within the ducting.

The protective grate 80 is then restored to its operational position across the filter system 10. The Intake air for the system resumes flow through the filter system 10 in the direction of the arrow 60.

Removal of less-than-particulate matter, e.g. odors and noxious gasses from the incoming air stream 60 to the HVAC system also is a significant feature of the invention. To accomplish this purpose a back-up secondary filter 82 (FIG. 2) is inserted selectively within the box 11 in a space 89 (FIG. 6) formed between the exposed filter fabric web 53 and a selectively removable supporting grid 83 (FIG. 2) that also is received within the box 11. Preferably, the secondary filter 82 is a porous carbon base filter that can provide a maximum level of air purification; e.g. a HEPA filter, which can be cleaned or replaced annually by removing the grid 83, removing the underlying secondary filter 82, replacing the removed filter with a fresh or cleaned secondary filter and replacing the grid 83 in the box 11.

Preferably, the activated carbon secondary filter 82 will be in a fixed mat state. Several manufacturers capable of producing a satisfactory product for this purpose are Dongguan Dihui Foam Sponge Co., Ltd. of Guangdong, China; Wuxi Yijing Purification Equipment Factory; Hangzhou Energy Technology Co., LTD.; and Fujian Sannong Calcium Carbonate Co., Ltd.

Also as shown in FIG. 2 the electric motor 61 drives an idler gear 84 that meshes through a gear 79 with the gear teeth 74 (FIG. 7B) on the winder gear 73. Electrical circuits including a circuit board 85 (FIG. 2) and batteries 86 that control the operation of the motor 61 and other functions for the filter system 10 are housed in a receptacle 87 (FIG. 1) that is provided with a selectively removable cover 90 (FIG. 2).

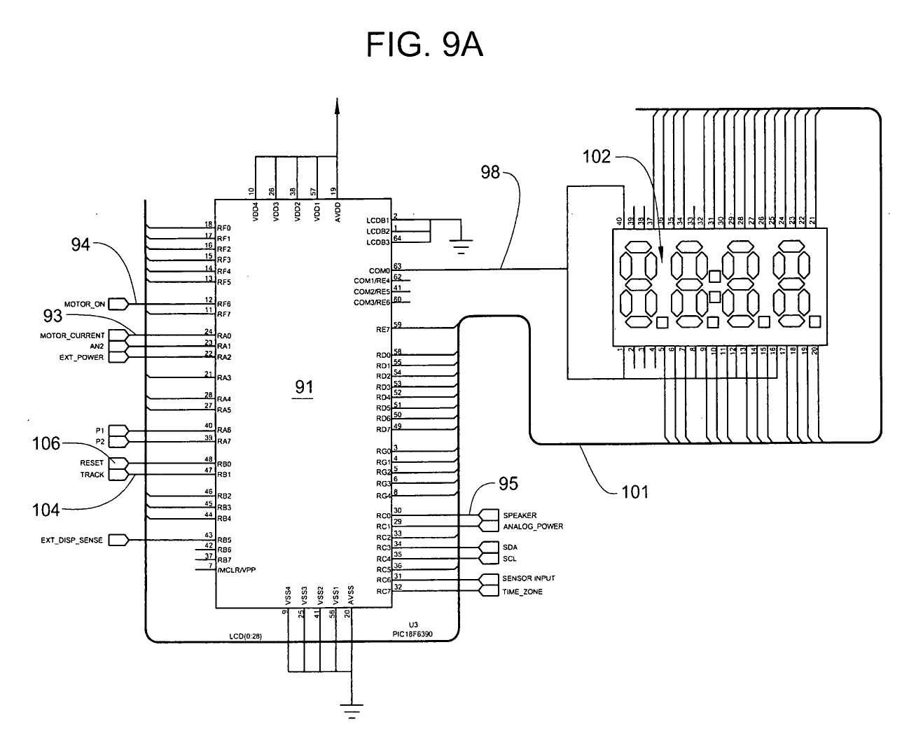

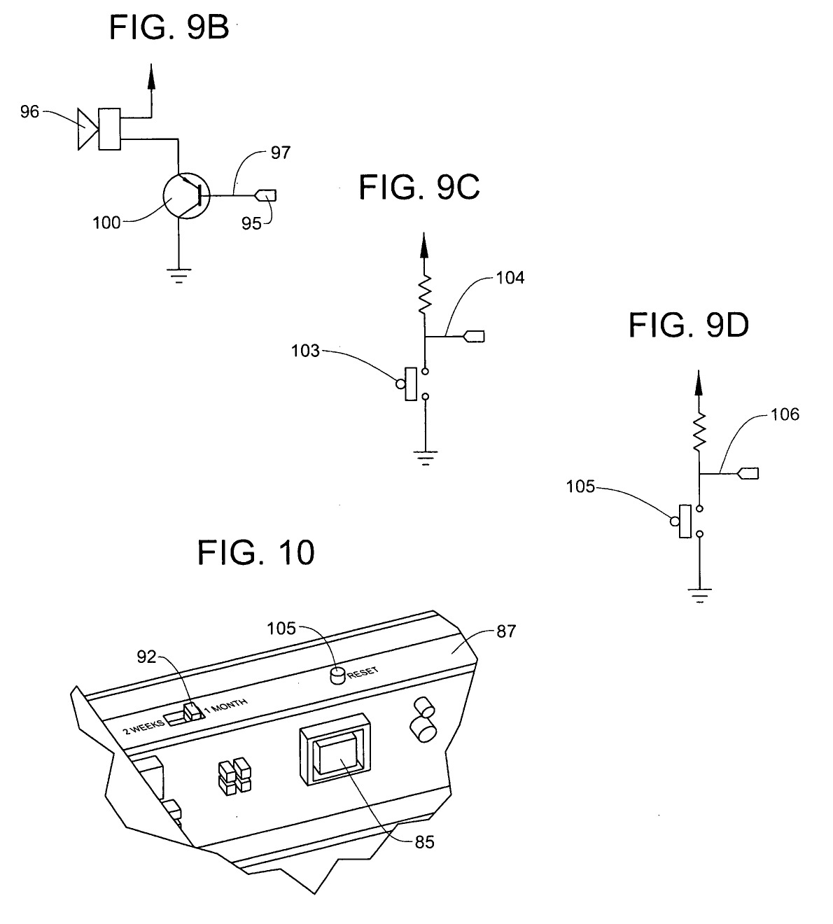

The individual circuits on the circuit board 85 are shown in the schematic wiring diagrams in FIG. 9A through 9D. Central to this operation is a microcontroller 91 (FIG. 9A) of which a Digikey—PIC 18F 4585, part PIC 18F 6390 is suitable for the purpose of the invention. The microcontroller 91, with its associated electrical circuits to be described subsequently in more complete detail, provide the following functions for the filter system:

1. Energizes and deenergizes the motor 61 and emits audible and visual signals through a selectively timed sequence of twelve steps, or cycles of predetermined duration to draw fresh webs of filter fabric from the supply roll and to store the contaminated web of filter fabric;

2. Emits an audible and visual warning at the eleventh cycle that a filter fabric roll replacement will be required in one more step;

3. Emits a different audible and visual warning that the roll of filter fabric must be replaced when at the twelfth cycle;

4. Resets the filter system when a new battery is installed;

5. Resets the cycle sequence when a fresh roll of filter fabric is installed;

6. Warns that the battery power has diminished to a level that is too low to operate the filter system effectively;

7. Proceeds through a full sequence of cycles including all of the audible and visual cues on installation of a fresh battery or a fresh roll of filter fabric to establish user familiarity with the system signals; and

8. Enables the filter fabric to be selectively advanced one cycle.

Taking each of the foregoing functions in order, attention now is invited to FIG. 10 which illustrates the receptacle 87 for the circuit board 85. Also shown in FIG. 10 is a two position toggle switch 92 in position to generate one fresh filter web advancing cycle every month for a total of twelve months. The other position for the toggle switch 92 shown in FIG. 10 enables the filter system to advance a fresh filter web once each two weeks.

This latter choice, advancing a web once every two weeks for a total term of twelve two-week cycles is preferred in dust laden atmospheres that tend to obstruct the filter fabric with particulate matter more swiftly and degrade the efficiency of the filter system 10. Naturally, through appropriate adjustment of the microcontroller 91, other cycle durations can be chosen, generally as a function of the intake air characteristics.

To accomplish these functions in the twelve month mode the microcontroller 91 in FIG. 9A is automatically activated to send a signal through a conductor 93 that energizes the motor 61. So energized, the motor 61 (FIG. 2) drives the gears 84, 79 and the winder gear 73 (FIG. 7B) to draw the web of filter fabric 53 (FIG. 6) of suitable length or span from the fresh filter fabric roll 52 against the tension established by the friction force between the supply mandrel 32 (FIG. 3) and the chucks 30, 33 and wind the contaminated web 78 (FIG. 6) onto the contaminated storage mandrel 55.

To deenergize the motor 61, perforations are provided (not shown in the drawing) in the lengthwise margin of the filter fabric roll at spacings equal to the proper span of the filter fabric web (FIG. 6). Several distinctive switch mechanisms can be activated through these perforations to deenergize the motor 61 and stop drawing fresh filter fabric from the supply roll 52. For example, a photoelectric cell (not shown in the drawing) is positioned on one side of the margin of the filter fabric in registration with the perforations. As a perforation becomes aligned with the photocell, a beam of light, passing through the perforation activates the photocell, sending a signal through a conductor 94 that cause the microcontroller 91 to deenergize the motor 61.

Among other alternative switching mechanisms for deactivating the motor 61, none of which are shown in the Drawing, a spring biased contact, also in registry with the filter fabric perforation, bears against the fabric. On alignment with a perforation in the fabric, however, electrical continuity is established with another contact on the opposite side of the fabric, thereby sending a signal to the microcontroller that also will deenergize the motor 61.

The microcontroller 91 with the toggle switch 92 in the position shown in FIG. 10 provides a timing circuit that blocks energizing the motor 61 for a period of one month, whereupon the microcontroller 91 starts the next cycle for advancing a fresh filter fabric web into position within the box 11 as the second cycle in the total of twelve cycles. As described below in more complete detail, the last two cycles, cycles eleven and twelve, do require special consideration.

In addition to advancing the fresh filter fabric web, the microcontroller 91 also sends a signal through a conductor 95 to a speaker 96 (FIG. 9B). The microcontroller signal in conductor 95 is applied to base electrode 97 in PNP transistor 100 that enables the transistor 100 to send an energizing current to the speaker 96, the pattern of noise emitted from the speaker identifying the fact that a cycle is being accomplished. At the same time, the microcontroller 91 also sends signals through cables 98 and 101 to a liquid crystal display (LCD) 102. This visual signal in the LCD 102 indicates the number of the cycle that is in progress, from the first to the tenth. In the eleventh cycle a different audible signal is emitted from the speaker 96 (FIG. 9B) to inform the user that a fresh roll of filter fabric will be required by the end of the next cycle. The visual cue displayed on the LCD 102 during the eleventh cycle is the signal “CPR” for “cartridge replacement phase.” On the twelfth and last cycle in the sequence, the speaker 96 will emit a rapid “beeping” noise and display the signal “CFI” in the LCD 102, the signal “CFI” being an acronym for the instruction “change filter immediately.”

Should any cycle fail to be completed within a predetermined number of seconds, the microcontroller 91 will emit a special signal that will cause the speaker 96 to emit a continuous audible tone and flash “ERR” in the LCD 102. These signals advise the user that a programmed cycle is not being completed. In this way the user is informed the need to correct a fault in the system.

In a similar manner with the toggle switch 92 (FIG. 10) set in a position opposite to that shown in the Drawing in order to complete each cycle in two weeks, all functions described above remain the same, except for the fact that the fresh filter fabric web is advanced only every two weeks.

A tracking switch 103 (FIG. 9C) is coupled to the microcontroller 91 (FIG. 9A) through a conductor 104. The tracking switch 104 is used to advance the fresh filter fabric web 53 (FIG. 6) forward by one cycle. As programmed in the microcontroller 91, the tracking switch 103 on being closed for three seconds will override the existing cycle and advance a fresh filter fabric web 53 to the next cycle. All audible and visual cues will remain the same as in a normal cycle advance situation. At the conclusion of this cycle advance, the filter system will resume normal operation.

This feature of the invention, for example, permits the user to change to a fresh filter web if the filter web in position has become heavily contaminated and to resume normal filter operation in the next cycle in the sequence.

Turning once more to FIG. 10, attention is invited to reset switch 105 that is used for resetting the filter system after a fresh roll of filter fabric is installed. As best shown in FIG. 9D, the reset switch 105 is coupled to the microcontroller 91 (FIG. 9A) through a conductor 106. The reset switch 105, as its name implies, will when closed for five seconds sends a signal through the conductor 106 to the microcontroller 91 (FIG. 9A) that resets the filter system 10. In order to so reset the system, however, the circuit 85 (FIG. 2) must be in the twelfth cycle, that is at the end of a full twelve cycles of operation. This is, moreover, the only time in the cycle sequence that the reset switch 105 will execute a function.

To replace the battery 86 (FIG. 2) that has been drained of power, the user first must note the number of the filter system's current cycle in the group of cycles from one to twelve. Remove the cover 90 from the receptacle 87 and disconnect the depleted battery 86, replacing it with a fresh, fully charged battery. The reset switch 105 (FIGS. 9D and 10) and the tracking switch 103 (FIG. 9C) are closed and held closed for three seconds. The LCD 102 (FIG. 9A) will display each for a few seconds and in numerical sequence, the cycle numbers 1 through 12. The user, however, should open the reset switch 105 and the tracking switch 103 when the cycle first noted above is reached.

At this point in the process the circuit 85 will pause for a few seconds and then advance to the next cycle in the numerical sequence, advancing a fresh filter fabric web into exposed position with the box 11.

On installing the filter system 10, the system 10 is activated by coupling a fresh battery 86 to the circuit 85. After the battery 86 is coupled to the circuit 85 the system will enter the twelfth cycle, the cycle in which a fresh filter fabric roll 52 (FIG. 6) is expected to be inserted into the box 11. After positioning the fresh fabric roll 52 in the box 11 in the manner described above, the reset switch 105 (FIG. 9D) is closed for five seconds. If the fresh filter fabric roll 52 has been properly inserted into the box 11 an appropriate visual cue, e.g. “RST” (for reset) will appear on the LCD 102 (FIG. 9A).

On opening the reset switch 105 the reset cue will be removed from the LCD 102 and the microcontroller 91 will undertake cycle one, the first cycle in the twelve cycle sequence. The sequence of twelve cycles will continue in numerical order along with the visual and audible cues associated with each of the respective cycles to include not only the fresh filter fabric roll replacement warning signals (for cycle eleven), but also the immediate fresh filter fabric roll replacement signals that are characteristic of the twelfth cycle. At this point a special successful cycle audible signal will sound to inform that the system has been properly reset and is ready to function. A particular advantage of this feature of the invention is the educational aspect in that it familiarizes the user with all of the cues that are to be expected from the system. It is, moreover, important to note that the system can only be reset when a fresh filter fabric roll has been inserted with the system in the filter replacement phase, that is in the twelfth cycle.

With respect to a low battery power replacement cue, a circuit can be provided to signal to the microcontroller 91 that the power in the battery 86 has been reduced to the level of unreliable operation. For example, the microcontroller 91, has an algorithm that enables the microcontroller 91 to read through a conductor (not shown in the Drawing) the decline in output from the battery 86. The microcontroller 91 at this point determines that the battery 86 output decrease in below benchmark criteria and generates an output signal. In response to this signal, the microcontroller 91 can, through the conductor 95, cause a suitable audible sound to issue and, through the cables 98, 101, enable the LCD 102 to generate an appropriate visual signal.

Thus, each of the salient features of the inventions described above can be practiced individually, in a lesser group or in their entirety. Nor is it necessary to restrict the filter system to only twelve cycles. Given appropriate circumstances it is within the scope of the invention to provide sequences of less than or more than twelve cycles.

Further in the regard, additional features of the invention also can be added to the filter system. By way of illustration, an electrically parallel circuit can be provided that, when coupled to the circuit 85, disables all, or an appropriate portion of the circuit 85. The parallel circuit, moreover, can be attached to the exterior of the grate 80 (FIG. 8) in order to make the visual cues presented by the LCD 102 (FIG. 9A) more readily visible.

Further in this regard, the circuit 85 can be coupled through an alternating current to direct current rectifier to the household electrical power system. In this way either dependence on the battery 86 can be eliminated or, if a rechargeable battery is used; the need that otherwise would exist to replace occasionally the battery 85 is avoided.

What is claimed is:

1. An incoming air filter for an air conditioner having a supply magazine for storing a roll of clean filter fabric wound on a hollow supply mandrel; a storage magazine for supporting a hollow storage mandrel for accumulating a roll of contaminated filter fabric, the storage magazine being separated from the supply magazine to establish a space therebetween for a web of the filter fabric from the stored roll of clean filter fabric and for exposing the filter fabric web to the incoming air; wherein the invention comprises a pair of stationary supply chucks each secured to opposite ends of the supply magazine, each of said supply chucks for being seated in a respective end of the hollow supply mandrel, said supply chucks each having diameters slightly greater that the associated supply mandrel diameter to create a friction force for drawing the web of filter fabric from the stored roll of clean filter fabric, a pair of selectively rotatable winder chucks each mounted for rotation on opposite ends of the storage magazine and to rotate the hollow storage mandrel, wherein said friction force created by said supply chucks with the supply mandrel is adequate to prevent undesirable wrinkle formation and slackness in the web of filter fabric.

2. An air filter according to claim 1 wherein said supply mandrel comprises a cardboard tube.

3. An air filter according to claim 1 further comprises an electric motor for selectively rotating said winder chucks.

4. A box for an air filter for an air conditioner that has a supply magazine for storing a roll of fresh filter fabric, a storage magazine for storing a roll of contaminated filter fabric spaced from the supply magazine to accommodate a web of fresh filter fabric therebetween, the web being positioned within the box and between the storage and supply magazine wherein the box further comprises a first curved surface adjacent to the supply magazine and having a radius of curvature at least slightly greater than the fresh filter fabric roll radius, a second curved surface adjoining the storage magazine having a radius of curvature at least slightly greater that the radius of the contaminated filter fabric roll radius, and a track formed in the box having an open side between the supply and storage magazine for receiving the web of filter fabric within the box.

5. A box according to claim 4 wherein the box further comprises a molded plastic structure.

6. A box for an air filter according to claim 4 wherein said box further comprises a selectively removable side for covering said open track side.

7. A box for an air filter according to claim 4 further comprising a plurality of detent couplings formed in the box to enable the supply and storage magazine to be selectively connected and disconnected to the box.

8. A box for an air filter system for insertion into the air inlet ducting for an air conditioner comprising, a peripheral step protruding from the perimeter of the box, and a flange on the interior of the air inlet ducting for engaging said peripheral step on the box and for supporting the air filter system within the air inlet ducting.

9. A box for an air filter system according to claim 8 wherein said peripheral step further comprises a three quarter of an inch protrusion, said protrusion being three quarters of an inch in depth.

10. A box for an air filter for an incoming air stream for an air conditioner that has a supply magazine for storing a roll of fresh filter fabric, a storage magazine for storing a roll of contaminated filter fabric spaced from the supply magazine to accommodate a web of filter fabric drawn from the roll of fresh filter fabric therebetween, the web being positioned within the box and between the storage and supply magazines, and a track formed in the box for receiving the web of filter fabric within the box, the box further comprising a back-up secondary filter positioned selectively in a space formed within the box adjacent to the filter web, said secondary filter further removing odors and noxious gases from the incoming air stream.

11. A box according to claim 10 further comprising a removable support grid within the box 11, said back-up secondary filter being sandwiched between said removable support grid and the filter fabric web.

12. A box according to claim 10 wherein said back-up secondary filter further comprises an activated carbon constituent for removing odors and noxious gases from the incoming air stream.

13. An electrical circuit for an air filter system for introducing a fresh web of filter fabric from a roll thereof into an incoming air stream for an air conditioner comprising a microcontroller for generating signals to regulate and to provide system status signals for the air filter system; an electric motor responsive to said microcontroller for selective activation in twelve time-spaced cycles to draw successive filter fabric webs into the incoming air stream, and means within said microcontroller from selectively varying the time-duration of each of said cycles.

14. An electrical circuit according to claim 13 wherein said microcontroller further comprises circuits responsive to said microcontroller for generating audible and visual cues characterizing the numerical sequence of the first ten of said twelve time-spaced cycles.

15. An electrical circuit according to claim 14 wherein said microcontroller signals said circuits for generating audible and visual cues to produce a special cue that is unique to said eleventh cycle.

16. An electric circuit according to claim 14 wherein said microcontroller signals said circuits for generating audible and visual cues to produce a special cue that is unique to said twelfth cycle and to maintain said twelfth cycle cue until said audible and visual cue circuits are deenergized.

17. An electrical circuit according to claim 14 further comprising a battery circuit for energizing the electrical circuit, and a reset switch for activating the electrical circuit in response to battery energization for the electrical circuit.

18. An electrical circuit according to claim 17 wherein said reset switch for activating the electrical circuit also resets said cycle sequence in response to the presence of a fresh roll of filter fabric in the air filter system.

19. An electrical circuit according to claim 17 wherein said microcontroller further comprises a circuit for generating audible and visual cues in response to said battery power declining to a level that fails to operate the air filter system effectively.

20. An incoming air filter system for mounting within the air inlet ducting of an air conditioner having a supply magazine for storing a roll of fresh clean filter fabric wound on a hollow supply mandrel, a storage magazine having a hollow storage mandrel for accumulating a roll of contaminated filter fabric, the storage magazine being separate from the supply magazine to establish a space therebetween for a web of the filter fabric drawn from stored roll of clean filter fabric and for exposing the filter fabric web to the incoming air, wherein the invention comprises a pair of stationary supply chucks each secured to opposite ends of the supply magazine, each of said supply chucks being received in a respective end of the hollow supply mandrel, said supply chucks each having diameters slightly greater that the associated supply mandrel diameter to create a friction force as the web of filter fabric is drawn from the stored roll of clean filter fabric, a pair of selectively rotatable winder chucks each mounted for rotation on opposite ends of the storage magazine and secured in respective ends of the hollow storage mandrel for rotation with said winder chucks, a box positioned between the storage and supply magazine, said box having a first curved surface adjacent to the supply magazine and having a radius of curvature at least slightly greater that the fresh filter fabric roll radius, a second curved surface adjacent to the storage magazine having a radius of curvature at least slightly greater than the radius of the contaminated filter fabric roll radius, a track formed in said box having an open side between the supply and storage magazine for receiving the web of filter fabric within said box, a peripheral step protruding from the perimeter of said box, a flange on the interior of the air inlet ducting for engaging said peripheral step on said box and for supporting the air filter system within the air inlet ducting, a back-up secondary filter positioned selectively in a space formed within said box adjacent to the filter web, and a removable support grid within said box, said back-up secondary filter being sandwiched between said removable support grid and the filter fabric web.
